(19) United States
(12) Patent Application Publication
(10) Pub. No.: US 2022/0048365 A1
(43) Pub. Date: Feb. 17, 2022

(54) HEATING BODY FOR A DEVICE FOR ELECTRICALLY HEATING AND CIRCULATING A LIQUID

(71) Applicant: Valeo Systemes Thermiques, Le Mesnil Saint Denis (FR)

(72) Inventors: Arnaud Faivre, Le Mesnil Saint Denis (FR); Hocine Daou, Le Mesnil Saint Denis (FR); Laurent Decool, Le Mesnil Saint Denis (FR)

(73) Assignee: Valeo Systemes Thermiques, Le Mesnil Saint Denis (FR)

(21) Appl. No.: 17/414,115

(22) PCT Filed: Dec. 6, 2019
(86) PCT No.: PCT/FR2019/052952

§ 371 Date: Jun. 15, 2021

(30) Foreign Application Priority Data
Dec. 18, 2018 (FR) 1873128

(51) Int. Cl. B60H 1/22; H05B 3/06; F24H 1/00; F24H 1/10

(52) U.S. Cl. CPC B60H 1/2221; H05B 3/06; F24H 1/009; B60H 2001/2271; H05B 2203/007; H05B 2203/021; F24H 1/102

(57) ABSTRACT

Heating body (I) for a device (16) for electrically heating liquid, said heating body (I) comprising at least one first helical heating element (4) defined by a diameter (di), a second helical heating element (5) defined by a diameter (d2), and a base (2) carrying the first and the second heating element (4, 5), characterized in that the first diameter (di) is greater than the second diameter (d2), and in that the first heating element is disposed around the second element. The heating body (I) can be configured so as to comprise three heating elements, or more, arranged such that the size in terms of length is limited, and could include a core, disposed so as to be surrounded by all of the different heating elements, reducing the volume of liquid inside the chamber (15) in which the heating body (I) is housed.

The field of the present invention is that of electrical devices for heating and circulating a liquid, in particular for a heating, ventilation and/or air-conditioning installation of an interior of a motor vehicle. More particularly, the invention relates to the electric heating devices used for such installations in electric or hybrid motor vehicles that are equipped with a high-voltage electric power supply network.

The air intended for the thermal treatment of the interior of a motor vehicle with a heat engine is heated by heat exchange between an air flow and a heat-transfer liquid, via a heat exchanger. In the case of hybrid or electric vehicles, electric heating devices are known that form a source of heat energy and in which an electric current is made to circulate so as to raise the temperature of a heating element built into this heating device. The liquid to be heated thus passes through the heating device and is brought into contact with the heating element, there is then an exchange of heat energy between the heating element and the liquid intended to heat the interior, which then in turn heats up.

The heating element usually consists of electric heating means, for example one or more heating resistors. In order to obtain heating power that is sufficient for the desired operation, it may be necessary to increase the number of heating elements in a single electric heating device. In a known manner, these heating elements can thus be aligned one after the other.

Such an arrangement nevertheless has the drawback of creating significant bulk due to the length of the electric heating device, in particular when the number of heating elements is increased in order to achieve the required performance levels.

Limiting the bulk created by the heating elements, while at the same time ensuring ever higher degrees of power and performance, remain essential issues for vehicles, in particular electric or hybrid motor vehicles, and it is in this context that the invention lies.

The aim of the present invention is thus to propose a heating body of which the power can be increased by adding heating elements while at the same time limiting the bulk created by the addition of such heating elements.

The subject of the present invention is a heating body for an electric liquid-heating device, said heating body comprising at least a first heating element of helical shape and defined by a diameter called the first diameter, a second heating element of helical shape defined by a diameter called the second diameter, and a base bearing the first heating element and the second heating element, characterized in that the first diameter is larger than the second diameter and in that the first heating element is disposed around the second heating element.

Such a heating body is intended for an electric heating device for a hybrid or electric motor vehicle and is, in particular, designed to operate with an electric power supply that is said to be of high voltage, generally higher than 50V. A heating element is understood to mean, for example, one or more electrical resistors that can be electrically connected in series or in parallel.

According to a particular embodiment, the base is provided with orifices allowing the insertion and fastening, in a sealed manner, of the various heating elements. In particular, in order to prevent deformation of the base bearing the various heating elements, said elements comprise a non-heating zone, located at their sites of insertion in the base.

According to a particular embodiment, each heating element is a helical tubular element. The tube of these heating elements thus forms, at a wound portion, a helix of specific diameter, defining the heating element.

In particular, the heating elements are arranged such that their wound portion extends by winding around an axis, called the winding axis, which is specific to the element. In particular, the points on a helical tubular element that are furthest from the winding axis are inscribed in an outer surface of the wound portion of the heating element. Likewise, the points on a helical tubular element that are closest to the winding axis are inscribed in an inner surface of the wound portion of the heating element. According to a preferential characteristic of the present invention, the various heating elements are disposed such that the winding axis of the first heating element is coincident with the winding axis of the second heating element. The diameter of the heating elements is thus equal to the diameter of a disk extending between the outer surfaces of the wound portion of the heating element, measured in a plane orthogonal to the winding axis.

According to a preferential characteristic of the present invention, the first heating element and/or the second heating element comprises a first terminal section, followed by the wound portion, followed by a second, rectilinear terminal section, the first terminal section and the second terminal section extending between the wound portion and the base. Each terminal section passes through the base and includes, at its free end, a terminal allowing the heating element to be connected to the electrical system.

The use of heating elements of helical shape makes it possible to reduce the bulk and also to increase the disturbance of the fluid passing through the electric heating device, thereby increasing the performance of said device.

The arrangement of the various heating elements of the present invention also contributes to preventing the increase in bulk that would result from simply adding the heating elements end to end, on a single axis, as has been observed in the prior art. According to the present invention, the heating body comprises at least two heating elements disposed such that the first heating element is wound around the second heating element, thus limiting the bulk of the heating body. Nevertheless, these heating elements, which are separate, preferably do not come into contact with one another, either at their own terminal sections or at their respective wound portions, which remain separated from one another.

When the electric heating device comprising the heating body of the present invention is assembled, a housing is fastened to the base, thus delimiting a chamber in which the various heating elements that make up the heating body of the present invention extend. Preferably, the heating body is arranged such that the points on the outer surface of the wound portion of each heating element are approximately equidistant from an inner surface of the housing.

In this way, a space for the circulation of a liquid in the chamber, around the heating elements, is defined, such a space being uniform from one end of the chamber to the other, thus allowing good distribution of the volumes of liquid. The liquid, such as glycol water, which is intended to be heated by the heating elements of the heating body, thus circulates in the chamber, between the various heating elements and, by contact with the heating elements, will rise in temperature.

Similarly, the various heating elements could, for example, be arranged such that the winding axis of the first heating element is coincident with the winding axis of the second heating element, such that the wound portion of the second heating element is centered inside the wound portion of the first heating element. In this way, it is possible to ensure circulation of flows of liquid of similar volumes all around the heating elements, and in particular in the space that exists between the outer surface of the wound portion of the second heating element and the inner surface of the wound portion of the first heating element, this space delimiting an intermediate annular zone.

In order to adapt the electric heating device to different required powers, the heating body can be configured so as to comprise three heating elements, or more, depending on the desired power.

When the heating body comprises a third heating element, which is itself also tubular and of helical shape, said third heating element is defined by a diameter called the third diameter.

In such a configuration, the heating body could be embodied in various forms.

In a first embodiment, the heating body is disposed such that the first heating element is disposed around the third heating element. The first heating element, of larger diameter, is thus arranged so as to be wound around the second and the third heating element.

Additionally, the third heating element can be disposed in the axial extension of the second heating element, the second heating element and the third heating element being wound around a common winding axis. Preferably, the second and the third heating element, which are thus placed end to end, are of identical diameter. The first heating element then preferably extends over a height that is equal, or substantially equal, to the height of the assembly formed by the second and third heating elements. This height is equal to the distance measured between the base, in which the heating elements are fastened, and the opposite end of the heating body, along the winding axis of the various heating elements.

The assembly formed by the second and the third heating element could, for example, be arranged such that the winding axes of each heating element are coincident. Thus, the assembly of the second and third heating elements is centered on the wound portion of the first element so as to ensure circulation of flows of liquid of similar volumes around the heating elements.

In a second embodiment, the heating body comprises at least one third heating element, of helical shape and defined by a diameter called the third diameter, the first heating element and the third heating element being disposed around the second heating element.

Thus, the third heating element is of a diameter similar to that of the first heating element and is disposed such that the first and the third heating element are end to end and are wound around a common axis. In such an embodiment, the first and the third heating element surround the second heating element; the diameter of the second heating element is therefore smaller than the diameter of the first heating element and of the third heating element.

The second heating element then preferably extends over a height that is equal, or substantially equal, to the height of the assembly formed by the first and the third heating element. Again, the second heating element could, for example, be arranged such that the winding axis of the assembly formed by the first and the third heating element is coincident with the winding axis of the second heating element.

The pitch of the wound portion of each heating element, i.e. the distance separating each turn, measured relative to the winding axis, can be adapted depending on the heating element, the embodiment, and the desired power. When two heating elements are arranged end to end, the helices of their respective wound portions will tend to have a small pitch, so as to limit their bulk.

The height of such an assembly of heating elements, placed end to end, will be measured along the winding axis of one of the heating elements. This height is equal, or substantially equal, to the sum of the height of the various wound portions of these various heating elements, to which is added the length of a first terminal section joining to the base the end of the wound portion that is closest to the base.

A heating element that is said to be elongate can be disposed either so as to wind two other heating elements, or so as to be surrounded by these two other heating elements, as shown in the second embodiment. In the first embodiment, the elongate heating element is thus the first heating element. In the second embodiment, the elongate heating element is thus the second heating element. The elongate heating element then preferably extends over a height that is similar, or substantially similar, to that of the assembly formed by the other two heating elements, placed end to end. In particular, the elongate heating element is characterized by a larger pitch than that measured in the heating elements disposed in the axial extension of one another.

Similarly, regardless of the configuration or embodiment of the present invention, the winding direction, clockwise or counterclockwise, of the wound portions of the various heating elements, will not be subject to any combination limitation. Winding direction is understood to mean the direction of the movement effected when following the extension of the turn of the wound portion of one of the heating elements. Thus, all of the heating elements can extend in a single winding direction, or the heating elements can be disposed in opposite winding directions.

According to a preferential characteristic of the invention, each terminal section contributes on the one hand to fastening the heating element in the base and on the other hand to electrically connecting the heating body to the electric power supply system. In particular, the second terminal section is attached to the wound portion by an elbow, this attachment being at the distal, relative to the base, region of the wound portion.

Preferably, the second terminal section extends over a length equal, or substantially equal, to the distance separating a distal, relative to the base, end of the wound portion, from the base. The second terminal section thus forms an arm that drops down from the distal end of the wound portion toward the base. Said elbow is preferably arranged so as to be disposed, relative to the first terminal section of the heating element, after a defined number of turns and an additional 360° turn to which is added an angular sector in degrees equal to a value corresponding to ±1.5 to 3R, R being the radius of the heating element, so as to prevent any encumbrance or contact between the various terminal sections of a single heating element.

According to a preferential characteristic of the present invention, the second terminal section of at least one of the heating elements extends toward the base, inside the wound portion of at least one heating element. In this way, independently of the number of heating elements making up the heating body, the second terminal portion can be disposed in a central zone, delimited by the diameter of the inner surface of the one or more heating elements of smaller diameter. Alternatively, this second terminal section could extend in the intermediate annular zone, situated between heating elements of different diameters.

In order to increase the power of the electric heating devices, it is also necessary to increase the heat exchange taking place between the heating elements and the liquid circulating in the device. Such a task can prove complex since it is also necessary to prevent any local boiling of the liquid. Specifically, when the chamber has a large volume, the liquid intended to be heated by the heating elements tends to stagnate in a central zone of the heating body and the heat exchange coefficient is thereby reduced.

In order to prevent such a drawback and to increase the performance of the electric heating device, a core can be disposed in the central zone.

According to an additional preferential characteristic of the present invention, the heating body can thus be equipped with a core extending in the direction defined by the winding axis of one or more heating elements, arranged such that the various heating elements are disposed around said core. This core preferentially extends over the height of the heating elements and aims to fill the central zone.

The addition of a core within the heating body makes it possible on the one hand to reduce the volume of liquid in the chamber and on the other hand to increase the disturbance of the flow of the liquid within the chamber. The coefficient of heat exchange between the liquid and the heating body will thus be increased and the performance of the device will be optimized.

Further characteristics, details and advantages of the invention will become more clearly apparent upon reading the detailed description given below, and several exemplary embodiments that are given by way of nonlimiting indication, with reference to the attached schematic drawings, in which:

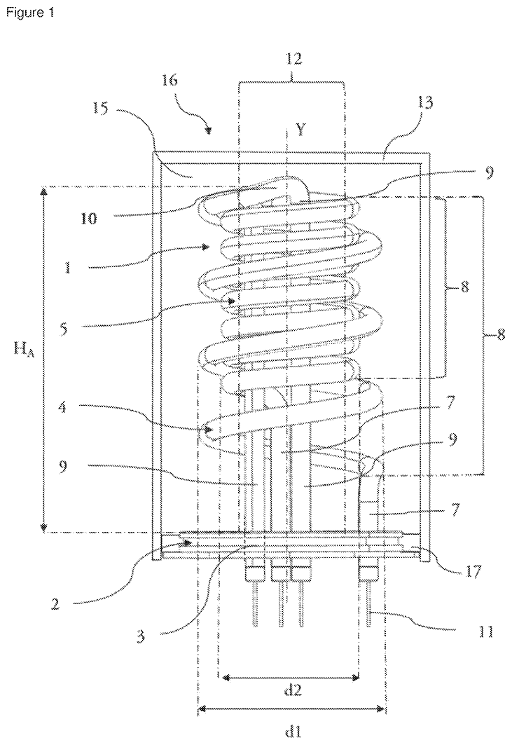

FIG. 1 is a side view of the electric heating device, when its heating body comprises two heating elements;

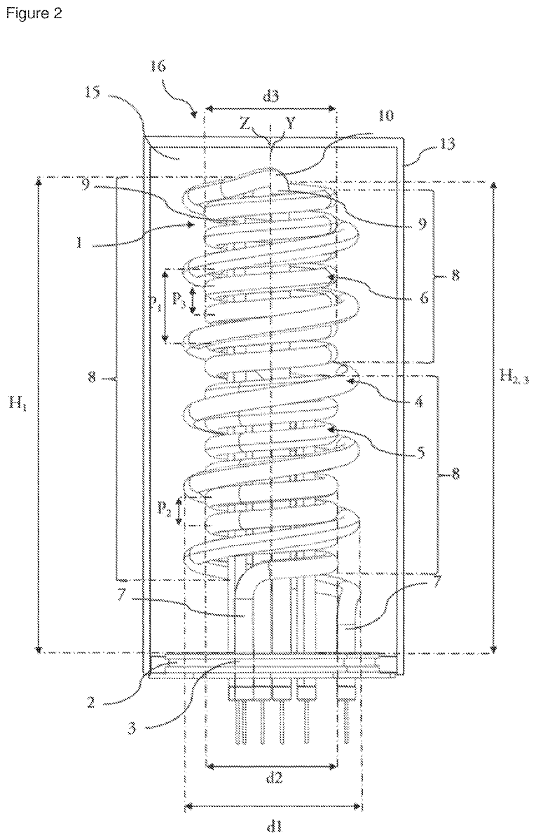

FIG. 2 is a lateral view of the electric heating device, when its heating body comprises at least three heating elements;

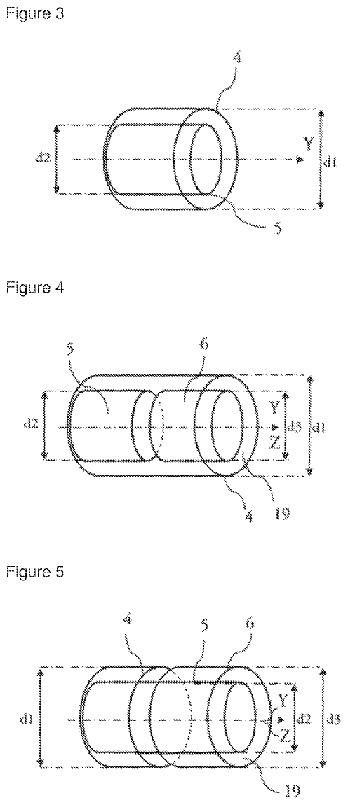

FIG. 3 is a schematic representation of a heating body comprising two possible heating elements for the present invention;

FIG. 4 is a schematic representation of a heating body comprising three heating elements, arranged according to a first embodiment;

FIG. 5 is a schematic representation of a heating body comprising three heating elements, arranged according to a second embodiment;

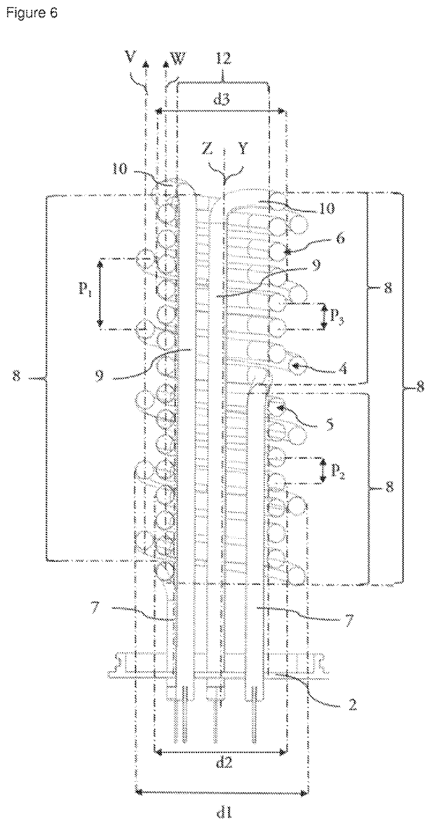

FIG. 6 is a vertical cross section of a heating body comprising three heating elements arranged according to a first embodiment, as shown in FIG. 2;

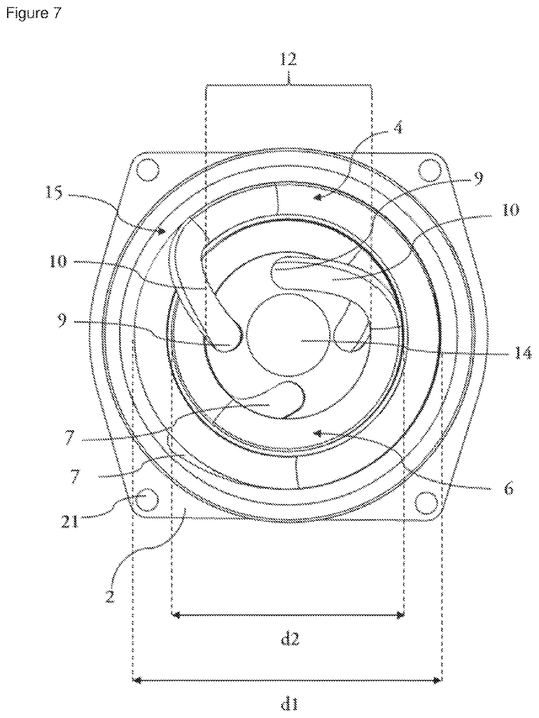

FIG. 7 is a top view of the heating body, when the latter comprises a core.

FIG. 1 schematically illustrates an electric heating device 16, comprising a base 2 bearing at least two heating elements 4 and 5 and to which a housing 13 is fastened, thus delimiting a chamber 15 in which the various heating elements 4 and 5 extend. The base 2 and the heating elements 4 and 5 form the assembly that is called the heating body 1. In order to seal the chamber 15, an annular seal 17 is disposed at the bottom of the heating body 1, in a receiving groove situated between the base 2 and the housing 13.

FIG. 1 presents, in particular, an electric heating device 16 of which the heating body 1 is configured to comprise two heating elements 4, 5, and shows the relative arrangement of the various heating elements 4, 5 within the electric heating device 16.

Each heating element 4, 5 is inserted and fastened, in a sealed manner, at orifices 3 made in the base 2, such that the liquid circulating in the chamber 15 cannot escape. Said heating elements 4, 5, are of tubular shape and are made up of a first terminal section 7, fastened to the base 2, continued by a wound portion 8 of helical shape, of which the helix extends in the direction defined by an axis Y, and ending with a second terminal section 9. Each terminal section 7, 9 is equipped at its end with a terminal 11 allowing the heating body 1 to be electrically connected to the electric power supply.

FIG. 1 shows a heating body 1 in which the second terminal sections 9 of each heating element 4, 5 extend in a rectilinear manner in a central zone 12, delimited by the inner surface of the wound portion of the second heating element 5. Alternatives to such an arrangement will nevertheless be discussed below.

The second terminal section 9 makes it possible to join the distal end, relative to the base 2, of the wound portion 8 to said base 2. In particular, a zone in which the distal end of the wound portion 8 and the second terminal section 9 are joined forms an elbow 10. The various elbows 10, and also the first and second terminal sections 7, 9 of each heating element 4, 5, are arranged such that there is no overlap or contact between the various terminal sections 7, 9. Such an arrangement will be illustrated in greater detail with FIGS. 6 and 7.

In the example shown in FIG. 1, the heating body 1 is configured so as to include only two heating elements 4 and 5. Said heating body 1 comprises a first heating element 4, defined by a first diameter d1, arranged such that this first heating element 4 is wound around the second heating element 5, defined by a second diameter d2 smaller than the diameter d1 of the first heating element 4.

The two heating elements 4, 5 can be arranged such that they are concentric, as illustrated in FIG. 1. The wound portions 8 of the various heating elements 4, 5 are then wound around a single axis Y. They extend in the chamber 15, over a height HA that is equal or substantially equal, measured along the same axis Y between the base and the distal end of the wound portion 8. The arrangement of the first and of the second heating element 4, 5 is defined such that these separate heating elements do not come into contact with each other, either at their own terminal sections 7 and 9 or at their wound portion 8.

When it is inserted into the housing 13, the heating body 1 is arranged such that, in a plane orthogonal to the axis Y, the points on the outer surface of the wound portion 8 of each heating element 4, 5 are equidistant, or substantially equidistant, from an inner surface of the housing 13, thus defining a space for circulation of the liquid in the chamber 15. In this way, the liquid circulates evenly through, around and inside the heating body 1, and rises in temperature upon contact with the various heating elements 4 and 5.

FIG. 2 and the schematic representation in FIG. 4 show a heating body 1 comprising three heating elements 4, 5 and 6, each of tubular and helical shape, and shows the arrangement of the various heating elements 4, 5, 6 according to a first embodiment. An alternative embodiment is shown schematically in FIG. 5.

In this first embodiment illustrated in FIG. 2, the heating body 1 comprises the first heating element 4, defined by the first diameter d1, which is wound around the second heating element 5, defined by the second diameter d2. The heating body 1 comprises a third heating element 6, defined by a third diameter d3. The various heating elements 4, 5, 6 are arranged such that this first heating element 4, defined by a first diameter d1 larger than d2 and d1 larger than d3, is wound around the second and the third heating element 5, 6. In particular, and as shown in FIG. 2, the third heating element 6 is disposed at the end of the second heating element 5 and these two heating elements have a common winding axis Y, which is coincident with the winding axis Z of the first element 4. The second and third heating elements 5, 6 are also defined by their equal diameters d2 and d3.

In such an arrangement, the various heating elements 4, 5 and 6 are at a non-zero distance from one another. In addition, the outer surface of the wound portion 8 of the second or of the third heating element 5, 6, and the inner surface of the wound portion 8 of the first heating element 4, delimit an intermediate annular zone 19, in the form of a more or less narrow ring, in which the liquid circulates.

The various heating elements 4, 5 and 6 extend in the chamber 15, which is delimited by the housing 13 and the base 2, in the direction defined by the axis Y. The first heating element 4 extends over a height H₁, measured between the base 2 and the distal end of the wound portion 8 of the first element 4, along the axis Y. This height H₁ is equal, or substantially equal, to the height H_{2,3}, measured along the axis Y, between the base 2 and a distal end of a wound portion 8 of the third heating element 6. This height H_{2,3} is the sum of the length of the second and third heating elements 5 and 6, when they are disposed end to end, and is measured along the axis Y.

As mentioned above for a heating body 1 comprising two heating elements 4, 5, the assembly of these three heating elements 4, 5 and 6 is preferably arranged such that, in a plane orthogonal to the axis Y, the points on a respective outer surface of a wound portion 8 of the various heating elements 4, 5, 6 are equidistant, or substantially equidistant, from an inner surface of the housing 13, so as to define a space for circulation of the liquid in the chamber 15 that is equally distributed.

The wound portion 8 of the first element 4, of diameter d1, which is larger than the diameters d2 and d3 of the second and third heating elements 5 and 6, in this embodiment has a pitch P₁ larger than the pitches P₂ or P₃ observed in the wound portion 8 of the second or third heating element 5, 6. The second and third heating elements 5, 6 illustrated in the heating body 1 in FIG. 2 have identical pitches P₂ and P₃. An alternative in which these pitches differ will nevertheless be conceivable.

Each heating element 4, 5, 6, comprises an elbow 10 extending, in a plane substantially perpendicular to the winding axis Y, toward the central zone 12 delimited by the inner surface of the wound portions of the second and third heating elements 5, 6. The elbow 10 of the third heating element is thus arranged such that the second terminal section 9 that is attached to it can extend rectilinearly in the central zone 12, from the wound portion 8 to a vacant space in the base 2, similarly to what has been explained above for the first and second heating elements 4, 5.

In the example shown in FIG. 6, the elbows 10 of each heating element 4, 5 and 6 extend toward the central zone 12, such that the second terminal sections 9 of each heating element 4, 5, 6 extend in this same central zone 12. It will nevertheless be possible to envisage alternatives in which one or more of the second terminal sections extend in the intermediate annular zone 19, which is located between the various heating elements 4, 5, 6.

This cross section along the Y axis illustrates a succession of turns that are vertically aligned on an axis V, belonging to the first heating element 4, followed by a succession of turns of the second and third heating element 5, 6, which are aligned vertically along an axis W that is separate from the axis V. The section of each heating element 4, 5, 6 is identical, illustrating the fact that they are composed of resistive strands of similar, or substantially similar, diameter.

FIG. 7 schematically illustrates a heating body 1 comprising a core 14 disposed at the center of the various heating elements 4, 5, 6. Such a core 14 can be integrated in all the configurations and embodiments of the heating body 1 as described above, regardless of the number of heating elements of which it is made up. This core 14 fills, at least partially, the central zone 12 of the heating body 1 and thus contributes to reducing the volume of the chamber 15, to increasing the disturbance of the flow of the heat-transfer liquid present in the chamber 15 and to accelerating the speed of movement of the liquid within this chamber 15. The presence of this core 14 thereby improves the performance of the heating body 1.

The core 14 is disposed in the central zone 12 and extends in the direction defined by the winding axis Y of the various heating elements 4, 5, 6 in the chamber 15. This core can be of variable height and extends over all or some of the length of the longest heating element. Nevertheless, a core of height approaching the height of the heating body 1 assembly surrounding said core 14 will preferably be adopted, so as to optimize the effect of the core 14.

FIG. 7 also illustrates fastening means 21, integrated in the base 2, which will make it possible to fasten the electric heating device of the present invention to the vehicle or to a support thereof.

It will be understood from reading the foregoing that the present invention proposes a heating body intended for an electric heating device, this heating body being configured to reduce the bulk of the electric heating device, while at the same time maintaining or increasing its thermal performance. The dimensions of this heating body, which is intended in particular to cooperate with a heating and/or air-conditioning apparatus for an electric or hybrid vehicle, are optimized as a result of the particular arrangement of the various heating elements. The addition of a core, disposed within this heating body, also has the effect of increasing the efficiency of the heat transfer that takes place between the heating elements and the liquid. The efficiency of the energy transfer is thereby increased, while the bulk of the electric heating device is reduced compared with the fluid-heating devices of the prior art.

The invention is not limited to the means and configurations described and illustrated herein, however, and also extends to all equivalent means or configurations and to any technically functional combination of such means. In particular, the number of heating elements, the pitch of the wound portions of said heating elements, the diameter of said heating elements can be modified without harming the invention, insofar as the electric heating device for a vehicle ultimately fulfills the same functionalities as those described in this document.

It will for example be possible to envisage a configuration in which one or more of the second terminal sections of the heating elements extend in the intermediate annular zone, and not in the central zone.

1. A heating body for an electric liquid-heating device, said heating body comprising:
at least a first heating element of helical shape and defined by a first diameter;
a second heating element of helical shape defined by a second diameter; and
a base bearing the first heating element and the second heating element,
wherein the first diameter is larger than the second diameter and the first heating element is disposed around the second heating element.

2. The heating body as claimed in claim 1, in which a winding axis of the first heating element is coincident with a winding axis of the second heating element.

3. The heating body as claimed in claim 1, wherein the first heating element and/or the second heating element comprises a first terminal section, followed by a wound portion, followed by a second, rectilinear terminal section, the first terminal section and the second terminal section extending between the wound portion and the base.

4. The heating body as claimed in claim 1, further comprising at least one third heating element, of helical shape and defined by a third diameter, the first heating element being disposed around the third heating element.

5. The heating body as claimed in claim 4, wherein the third heating element is disposed in the axial extension of the second heating element, and the second heating element and the third heating element wound around a common axis Y.

6. The heating body as claimed in claim 1, further comprising at least one third heating element, of helical shape and defined by a third diameter called the third diameter, the first heating element and the third heating element being disposed around the second heating element.

7. The heating body as claimed in claim 6, wherein the third heating element is disposed in the axial extension of the first heating element, such that the first heating element and the third heating element are wound around a common axis Y.

8. The heating body as claimed in claim 1, wherein the second terminal section of at least one of the heating elements extends toward the base, inside the wound portion of at least one heating element.

9. The heating body as claimed in claim 2, further comprising a core extending in the direction defined by a winding axis of the various heating elements, arranged such that the various heating elements are disposed around said core.

10. An electric heating device comprising:
a heating body comprising:
at least a first heating element of helical shape and defined by a first diameter,
a second heating element of helical shape defined by a second diameter, and
a base bearing the first heating element and the second heating element,
wherein the first diameter is larger than the second diameter and the first heating element is disposed around the second heating element; and
a housing fastened to the base,
the heating body and the housing delimiting a chamber in which at least the first and second heating elements extend.

11. The heating body as claimed in claim 1, wherein the base is provided with orifices allowing the insertion and fastening, in a sealed manner, of at least the first and second heating elements.

12. The heating body as claimed in claim 11, wherein, in order to prevent deformation of the base bearing at least the first and second heating elements, said first and second heating elements comprise a non-heating zone located at sites of insertion in the base.
